(19) United States
(12) Patent Application Publication
(10) Pub. No.: US 2006/0227795 A1
(43) Pub. Date: Oct. 12, 2006

(54) Optimized method of reading data packets communicated over a network

(76) Inventors: Amit Bande, Bangalore (IN); Krishna Mohan I.V., Bangalore (IN); Sreekumar K. Seshadri, Bangalore (IN)

Correspondence Address: HICKMAN PALERMO TRUONG & BECKER/ORACLE, 2055 GATEWAY PLACE, SUITE 550, SAN JOSE, CA, 95110-1089, US

(21) Appl. No.: 11/156,070

(22) Filed: Jun. 17, 2005

(30) Foreign Application Priority Data
Apr. 7, 2005 (IN) 286/KOL/2005

(51) Int. Cl. H04J 3/16; H04J 3/22; H04L 12/56; H04L 12/28

(52) U.S. Cl. 370/412; 370/465

(57) ABSTRACT

Techniques are described for reading a plurality of data packets, which can be communicated over a network, without sacrificing the efficiency of network operation, and for reading data packets communicated over a network without unnecessary memory copies. A receive buffer of a first size, which is at least twice a maximum size of data packets in the plurality of data packets, is used. A first amount of data is read into the receive buffer and the size of a last packet contained within the first amount of data is determined. The size of an unread portion of the last read packet is determined and a second amount of data, which is equal to size of an unread portion of the last read packet, is then read into the receive buffer.

### CROSS REFERENCE TO RELATED APPLICATION

This application is related to and claims the benefit of priority from Indian Patent Application No. 286/KOL/2005, filed on Apr. 7, 2005, entitled “AN OPTIMIZED METHOD OF READING DATA PACKETS COMMUNICATED OVER A NETWORK”, the content of which is incorporated by this reference in its entirety for all purposes as if fully disclosed herein.

### FIELD OF THE INVENTION

The present invention relates generally to the field of data communications. More specifically, the present invention relates to an optimized method for data packet communication.

### BACKGROUND

When information is in the form of data packets containing header followed by data and an application communicates in terms of packets over a network the application may read the data packets in one of the following two ways:

Read one data packet at a time, first reading the header and then reading the rest of the packet.

Alternatively, the application may also read in the maximum size of the data packet. Thus, if X is the maximum size, the application can read X bytes at a time.

The first approach, that is reading one data packet at a time will lead to inefficient network operation. In the network operation for reading the data from the wire read system call is used. When we call read the data is copied from the wire to the buffer address provided.

This call consumes CPU cycles, and therefore, lesser number of times it is called the better. For example, when 100 bytes are to be read, a single read of 100 bytes will take less CPU cycles than two reads with 50 bytes each.

Thus, when the header is read first and then the rest of the data of the packet is read, the efficiency comes down. In other words, in terms of CPU cycles, a single read for reading the entire packet into the buffer would be more efficient.

In the second approach, that is, reading X bytes at a time where X is the send buffer size, at a time, it may lead to additional partial data packets in the receive buffer apart from the main data packet. These partial data packets will, most probably, be towards the end of the buffer and are difficult to handle. This is because they have to be moved to the beginning of the buffer by a memory copy operation for ensuring contiguous location of the contents of the data packets.

In the second approach, X bytes are read at a time where X is the buffer size. The maximum packet size is also X.

Now let us consider an example where buffer size X is equal to 1000 bytes and two data packets P1 and P2 are received from a remote machine having sizes of 800 bytes 500 bytes respectively. In order to avoid the overhead of multiple read, as discussed under the first approach of reading, a single read of 1000 bytes will be made as there is no way to know in advance that data packet P1 will then occupy position 0 to 800 and data packet P2 will occupy position 801 to 1000. Thus data packet P2 has not been read completely and only 200 of the 500 bytes have been read. The remaining 300 bytes are still on the wire.

When the program has consumed data packet P1 and needs the data packet P2, the rest of the packet P2 cannot be read as it is already at the end of the buffer (position 801 to 1000). For reading the entire data packet P2, it has to be moved/copied to the beginning of the buffer (position 0-2000) and then a read issued to read the remaining 300 bytes. This memory copy takes more CPU cycles. They are quite expensive and degrades the performance as the program consumes more CPU cycles. This extra memory copy should therefore, be avoided.

Therefore, there exists a need for a method for reading complete packets with efficient network operation.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates a method according to an embodiment of invention;

FIG. 2 is a block diagram that illustrates an example of the environment in which an embodiment of the invention may be implemented;

FIG. 3 is a block diagram that illustrates a digital processing system on which an embodiment of the invention may be implemented; and

FIG. 4 is a block diagram of a computer system on which an embodiment of the invention may be implemented.

### DETAILED DESCRIPTION OF EMBODIMENTS OF THE INVENTION

Functional Overview

One aspect of embodiments of the invention is an optimized method for reading a plurality of data packets, which can be communicated over a network, without sacrificing the efficiency of network operation.

Another aspect of embodiments of the invention is a method of reading data packets communicated over a network without unnecessary memory copies.

One more aspect of embodiments of the invention is a computer readable medium embodying a set of computer-readable instructions for causing a computer system to read a plurality of data packets.

Yet another aspect of embodiments of the invention is an apparatus for reading a plurality of data packets communicated over a network.

Thus in a first embodiment the invention provides a method for reading a plurality of data packets by using a receive buffer of a first size which is at least twice a maximum size of data packets in the plurality of data packets. A second amount of data can be read into the receive buffer which is at most half of the first size. A third size of a last packet contained within the second amount of data can then be determined. A fourth size of an unread portion of the last read packet is determined and a fourth amount of data is then read into the receive buffer, which is equal to the determined fourth size.

The data packets can be formatted according to TCP/IP protocol. The data packets can be received over computer network and read from a network communication medium. The receive buffer can be allocated in a main computer memory.

The method further comprises processing the data packets read into the receive buffer. Such processing may involve storing the data packets on a storage medium comprising a non-volatile storage medium.

After step (e) the receive buffer can be cleared and steps (a) through (e) can be repeated. The first size can be adjusted based on a size of packets read into the receive buffer.

Information on packets read into the receive buffer can be stored.

In a second embodiment the invention provides a method for reading a plurality of data packets, by using a receive buffer of a first size; which is at least twice a maximum size of data packets in the plurality of data packets. A second amount of data is read into the receive buffer, which is at most half of the first size. A last read packet of data read into the receive buffer is identified and the data is read into the receive buffer until an end of the identified packet of data.

In a third embodiment the invention provides a method for reading a plurality of data packets by using a receive buffer of a first size; which is at least twice a maximum size of data packets in the plurality of data packets. A second amount of data is read into the receive buffer, which is at most half of the first size; and an additional data is read into the receive buffer such that the receive buffer contains only complete data packets.

Another aspect of embodiments of the invention involves a computer readable medium embodying a set of computer-readable instructions for causing a computer system to provide a receive buffer of a first size which is at least twice a maximum size of data packets in the plurality of data packets. A second amount of data is read into the receive buffer, which is at most half of the first size. A third size of last packet contained within the second amount of data is determined. A fourth size of an unread portion of the last read packet is determined and a fourth amount of data is read into the receive buffer, which is equal to the determined fourth size.

A third aspect of embodiments of the invention involves an apparatus for reading a plurality of data packets. The apparatus comprises a receive buffer of a first size; which is at least twice a maximum size of data packets in the plurality of data packets.

An interface unit is provided for reading a second amount of data into the receive buffer, which is at most half of the first size; and the interface unit reads an additional data into the receive buffer such that the receive buffer contains only complete data packets.

The receive buffer of the apparatus is allocated within a main memory of the computer system. The interface unit of the apparatus comprises a network interface card or a disk controller. The apparatus can be provided with a processing unit for processing the data packets read into the receive buffer.

The apparatus may also include a data store for storing the data packets during the processing of the data packets by the processing unit.

In the following detailed description, reference will be made to the accompanying drawings. The aforementioned accompanying drawings show by way of illustration, and not by way of limitation, specific implementations consistent with principles of embodiments of

the invention. These implementations are described in sufficient detail to enable those skilled in the art to practice the invention and it is to be understood that other implementations may be utilized and that structural changes may be made without departing from the scope and spirit of present invention. The following detailed description is, therefore, not to be construed in a limited sense.

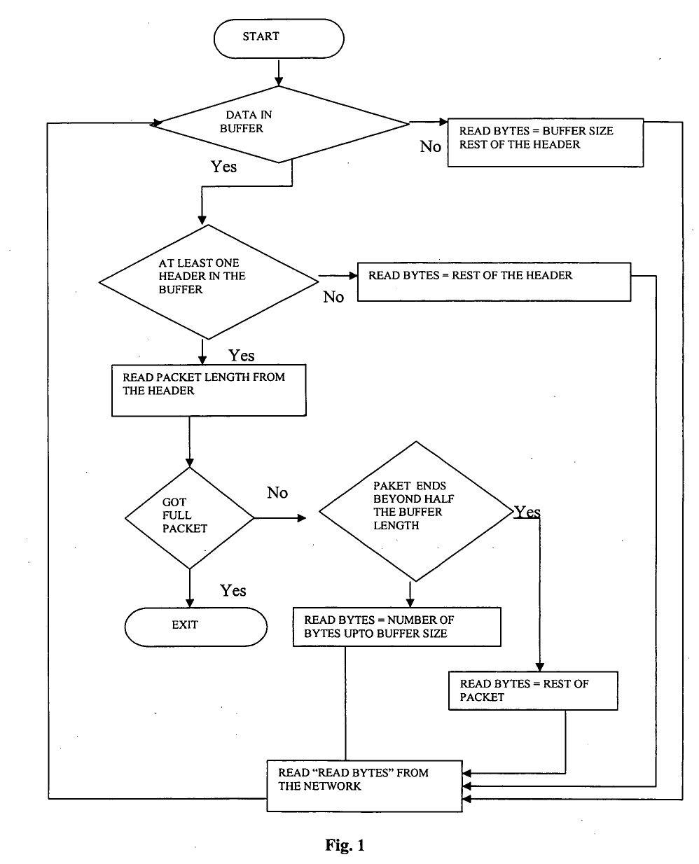

The flow chart of FIG. 1 is recursive in the sense that it continues to read till it does not get at least one complete packet. Considering the send buffer size as 1000 bytes, the receive buffer size will be 2000 bytes. If the sender has two data packets, one packet P1 of 800 bytes and the other packet P2 of 500 bytes and if each packet has a header of 10 bytes, then packet P1 will have 10 bytes header and 790 bytes data followed by packet P2 with 10 bytes header followed by 490 bytes data. The receiver may find out the length of the data packet only after it has the complete header. When the receiver is yet to receive the first packet, its buffers are empty. The receive size can be sent to buffer size, that is 1000 read bytes and read from the wire. Header of data packet P1 is received followed by P1 data, followed by header and partial data packet P2. On receipt of the complete packet P1, the receiver can exit, that is return the data packet to the caller.

Upon finishing consumption of data packet P1, data packet P2 is needed from the wire and the above algorithm is called again.

The data present in the buffer may be in one of the following combinations:

(a) Partial header (This would have occurred if size of data packet P1 had been 995 bytes, so the buffer would have contained P1—10 bytes header, 985 bytes data, P2—5 bytes header);

(b) Complete header, but a partial packet (This can be seen in the case mentioned earlier and packet P1—10 bytes header, 790 bytes data packet P2—10 bytes header, 190 bytes data. The remaining 300 bytes of data packet P2 are still on the wire);

(c) Complete header, complete data (This would have occurred if the size of the data packet P2 had been 200 bytes.

In the case of situation (a) first the rest of the header should be read before the rest of the data is fetched. Read bytes can be set to the size of the remaining header and then read that from the wire. Receiver can then go back to the beginning of the algorithm.

In the case of situation (c) the data packet P2 can just be returned to the caller by going to exit, which returns the packet to the caller.

In the case of situation (b), considering the example where

P1=500 bytes (10 bytes header, 490 bytes data),

P2=300 bytes (10 bytes header, 290 bytes data) and

P3=400 bytes (10 bytes header, 390 byte data);

when the receiver makes a read, consider that it reads 600 bytes packet (P1—500 bytes+packet P2—100 bytes). Also it has finished consuming data packet P1 and now needs data packet P2, so it calls the algorithm.

Data is present in the buffer with a complete header for data packet P2. There is also partial data for data packet P2 in the buffer and possible combinations are:

(a) Data packet P2 ends within buffer limit i.e. within 1000 bytes, as in this case.

(b) Data packet P2 ends beyond buffer size. This would be the case if size of P2 in this case had been 800 bytes.

In the case of situation (a) the receiver can read up to the end of the buffer, in this case read bytes will equal to 400 bytes and read from the network.

In the case of situation (b), the receiver can read only up to the end of the packet i.e. 700 bytes. No read is done beyond this as to header should be present in the second half of the receive buffer.

It should be understood that processes and techniques described herein are not inherently related to any particular apparatus and may be implemented by any suitable combination of components. Further, various types of general purpose devices may be used in accordance with the teachings herein. It may also prove advantageous to construct specialized apparatus to perform the method steps described herein.

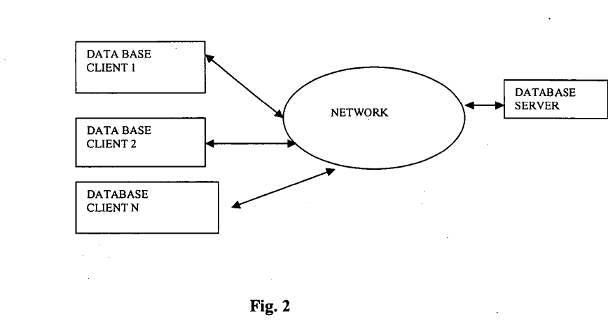

FIG. 2 shows a network diagram which can be used to carry the package from the data base clients to the server. The example environment shown in FIG. 2 in which an embodiment of the invention can be implemented, comprises data base clients 1 to N connected to the data base server by a network. The components shown in this figure are just representative components so as not to obscure the features of embodiments of the invention. The network may contain several devices based on the protocols used, such as TCP/IP, or a point to point protocol.

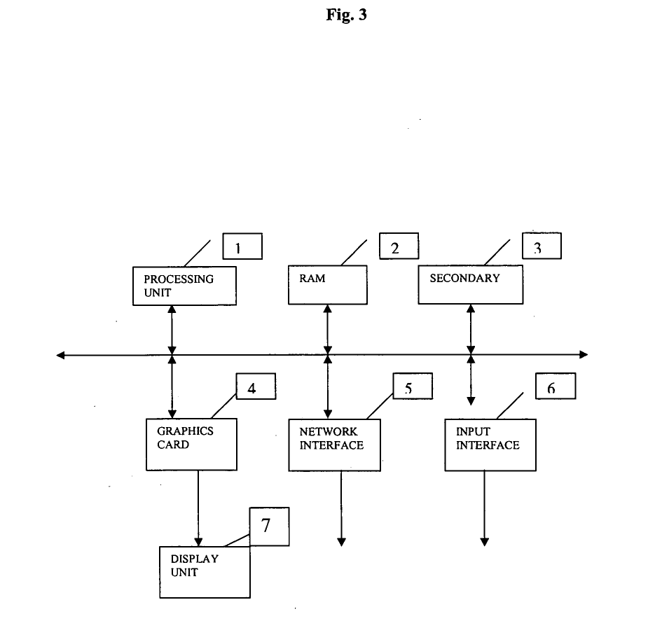

A digital processing system implemented in the form of software according to embodiments of the invention and illustrated in FIG. 3 comprises a processing unit 1 for executing instructions stored in a RAM 2. The processing unit 1 may contain one or more CPUs. The instructions and data are stored in a secondary storage 3. From here, these might be loaded into the RAM 2 and then executed in the processing unit 1. All these components interact using a bus as shown in FIG. 3.

A graphics card 4 generates signals that are sent to a display unit 7. The display unit 7 may consist of a display screen, to display the images defined by display signals. An input interface 6 may receive signals from a keyboard, mouse or any input device not shown. A network interface 5 may be connected to the network as shown in FIG. 3 and may act as both an input as well as an output device.

Embodiments of the present invention have been described in relation to particular examples, which are intended in all respects to be illustrative rather than restrictive. Those skilled in the art will appreciate that many different combinations of hardware, software, and firmware will be suitable for practicing the embodiments.

The various aspects, features, components and/or embodiments of the present invention described above may be embodied singly or in any combination in a data processing and/or storage system such as database.

Moreover, other implementations of embodiments of the invention will be apparent to those skilled in the art from consideration of the specification and practice of embodiments of the invention disclosed herein. It is intended that the specification and examples be considered as exemplary only, with a true scope and spirit of the invention being indicated by the following claims.

Hardware Overview

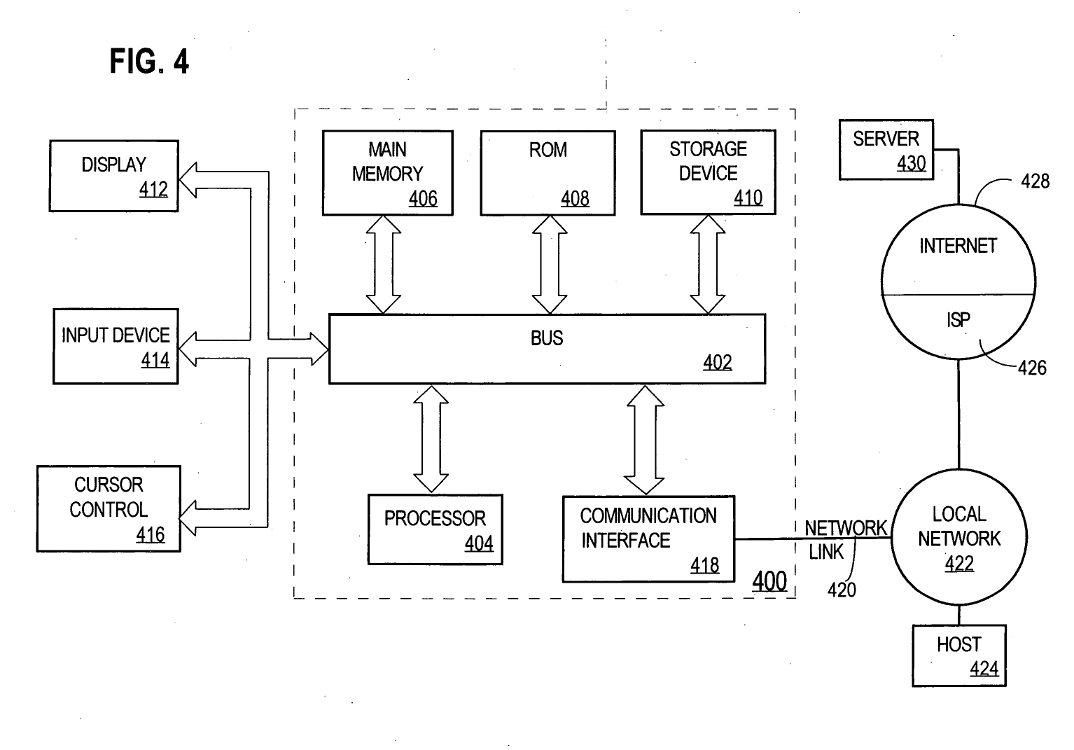

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Embodiments of the invention are related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for reading a plurality of data packets, the method comprising:
a. providing a receive buffer of a first size; wherein the first size is at least twice a maximum size of data packets in the plurality of data packets;
b. reading a first amount of data into the receive buffer, wherein the first amount of data is at most half of the first size;
c. determining a second size of a last packet contained within the first amount of data;
d. determining a third size of an unread portion of the last read packet; and
e. reading a second amount of data into the receive buffer, wherein the second amount of data is equal to the determined third size.

2. The method of claim 1, wherein the data packets are received over computer network.

3. The method of claim 1, wherein the data packets are formatted according to TCP/IP protocol.

4. The method of claim 1, wherein the receive buffer is allocated in a main computer memory.

5. The method of claim 1, wherein the data packets are read from a network communication medium.

6. The method of claim 1, further comprising (f) processing data packets read into the receive buffer.

7. The method of claim 6, wherein the processing comprises storing the data packets on a storage medium.

8. The method of claim 7, wherein the storage medium comprises a non-volatile storage medium.

9. The method of claim 1, further comprising (f) clearing the receive buffer and repeating the (a) through (e).

10. The method of claim 1, further comprising (f) adjusting the fist size based on a size of packets read into the receive buffer.

11. The method of claim 1, further comprising (f) storing information on packets read into the receive buffer.

12. A computer-implemented method for reading a plurality of data packets, the method comprising:
a. providing a receive buffer of a first size; wherein the first size is at least twice a maximum size of data packets in the plurality of data packets;
b. reading a first amount of data into the receive buffer, wherein the first amount of data is at most half of the first size;
c. identifying a last read packet of data read into the receive buffer; and
d. reading data into the receive buffer until an end of the identified packet of data.

13. A computer-implemented method for reading a plurality of data packets, the method comprising:
a. providing a receive buffer of a first size; wherein the first size is at least twice a maximum size of data packets in the plurality of data packets;
b. reading a first amount of data into the receive buffer, wherein the first amount of data is at most half of the first size; and
c. reading an additional data into the receive buffer such that the receive buffer contains only complete data packets.

14. A machine-readable medium carrying one or more sequences of instructions which, when executed by one or more processors, causes the one or more processors to perform the method recited in claim 1.

15. A machine-readable medium carrying one or more sequences of instructions which, when executed by one or more processors, causes the one or more processors to perform the method recited in claim 12.

16. A machine-readable medium carrying one or more sequences of instructions which, when executed by one or more processors, causes the one or more processors to perform the method recited in claim 13.

17. An apparatus for reading a plurality of data packets, the apparatus comprising:
d. a receive buffer of a first size; wherein the first size is at least twice a maximum size of data packets in the plurality of data packets;
e. an interface unit for reading a first amount of data into the receive buffer, wherein the first amount of data is at most half of the first size; and wherein the interface unit reads an additional data into the receive buffer such that the receive buffer contains only complete data packets.

18. The apparatus of claim 17, wherein the receive buffer is allocated within a main memory of a computer system.

19. The apparatus of claim 17, wherein the interface unit comprises a network interface card.

20. The apparatus of claim 17, wherein the interface unit comprises a disk controller.

21. The apparatus of claim 17, further comprising (c) a processing unit for processing data packets read into the receive buffer.

22. The apparatus of claim 21, further comprising (d) a data store, wherein during the processing of the data packets by the processing unit, the data packets are stored in the data store.
